(19) United States
(12) Patent Application Publication
(10) Pub. No.: US 2005/0176371 A1
(43) Pub. Date: Aug. 11, 2005

(54) Synchronization of time-frequency codes

(76) Inventors: Arto Palin, Viiala (FI); Jukka Reunamaki, Tampere (FI)

Correspondence Address: MORGAN & FINNEGAN, L.L.P., 3 WORLD FINANCIAL CENTER, NEW YORK, NY, 10281-2101, US

(21) Appl. No.: 10/773,287

(22) Filed: Feb. 9, 2004

(51) Int. Cl. H04M 5/00

(52) U.S. Cl. 455/41.2; 455/39

(57) ABSTRACT

A frequency hopping pattern associated with a remote short-range wireless communications network is identified. Based on the identified frequency hopping pattern, a frequency hopping pattern for communications in a local short-range wireless communications network is selected. In addition, a timing for the selected frequency hopping pattern is selected based on the identified frequency hopping pattern timing. One or more symbols, such as OFDM symbols, may be transmitted according to the selected frequency hopping pattern and the selected timing.

### FIELD OF THE INVENTION

The present invention relates to wireless communications. More particularly, the present invention relates to techniques for controlling the frequency hopping and timing of wireless transmissions.

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

IEEE 802.15.3 defines an ad hoc wireless short-range network (referred to as a piconet) in which a plurality of devices may communicate with each other. One of these devices is called piconet coordinator (PNC), which coordinates timing and other operational characteristics. The remaining devices in the network are known as DEVs. The timing of piconets is based on a repeating pattern of “superframes” in which the network devices may be allocated communications resources.

A high rate physical layer (PHY) standard is currently being selected for IEEE 802.15.3a. The existing IEEE 802.15.3 media access control layer (MAC) is supposed to be used as much as possible with the selected PHY. Currently, there are two remaining PHY candidates. One of these candidates is based on frequency hopping application of orthogonal frequency division multiplexing (OFDM). The other candidate is based on M-ary Binary offset Keying. The OFDM proposal is called Multiband OFDM (MBO). More information about Multiband OFDM can be found from http://www.multibandofdm.org/.

MBO utilizes OFDM modulation and frequency hopping. MBO frequency hopping involves the transmission of each of the OFDM symbols at one of three frequency bands according to pre-defined code, referred to as a Time Frequency Code. Time Frequency Codes (TFCs) can be used to spread interleaved information bits across a larger frequency band.

In addition, multiple-access can be achieved by utilizing different TFCs for adjacent piconets. Unfortunately, multiple simultaneously operating piconets (SOPs) are not guaranteed, because, with a limited number of frequency bands, collisions between different codes can happen quite often. However, the proper timing and TFC selection of transmissions can significantly reduce (and even eliminate) such collisions. Accordingly, techniques are needed to establish the timing of frequency hopping transmissions.

### SUMMARY OF THE INVENTION

The present invention provides a method and system that identifies a frequency hopping pattern associated with a remote short-range wireless communications network. In addition, the method and system select a frequency hopping pattern for communications in a local short-range wireless communications network based on the identified frequency hopping pattern, and select a timing for the selected frequency hopping pattern based on the identified frequency hopping pattern timing. Further, one or more symbols (such as OFDM symbols) may be transmitted according to the selected frequency hopping pattern and the selected timing.

Selecting a timing for the selected frequency hopping pattern may include monitoring transmissions in a frequency band; identifying a low energy condition in the frequency band; and designating a starting time for the selected frequency hopping pattern during the low energy condition.

In aspects of the present invention, the identified frequency hopping pattern and the selected frequency hopping pattern may be the same. Accordingly, the selected timing may provide for no collisions between the identified frequency hopping pattern and the selected frequency hopping pattern. Alternatively, the identified frequency hopping pattern and the selected frequency hopping pattern may be different.

The method and system may also direct one or more remote wireless communications devices to employ the selected frequency hopping pattern. The identified and selected frequency hopping patterns may be based on various time frequency codes.

The present invention also provides a wireless communications device having a carrier sensing module, a timing controller, and a transceiver. The carrier sensing module is configured to monitor transmissions in one or more frequency bands. In aspects of the present invention, the timing controller selects a frequency hopping pattern for a local short-range wireless network based on a frequency hopping pattern of a remote short-range wireless communications network detected by the carrier sensing module. In addition, the timing controller controls one or more transmission times according to the selected frequency hopping pattern. This is based on energy levels detected in a frequency band by the carrier sensing module. The transceiver transmits data at the one or more data transmission times according to the selected frequency hopping pattern.

In further aspects, the transceiver receives the frequency hopping pattern from a device in the local short-range wireless communications network. The timing controller controls one or more transmission times according to the frequency hopping pattern. This is based on energy levels detected in a frequency band by the carrier sensing module. In addition, the transceiver transmits data at the one or more data transmission times according to the frequency hopping pattern.

The present invention advantageously reduces (or even eliminates) the number of collisions between transmissions. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an available spectrum for a short-range communications system in which the principles of the present invention may be applied;

FIG. 2 is a diagram showing spread spectrum signal transmission according to a particular time frequency code;

FIG. 3 is a table showing various time frequency codes;

FIG. 4 is a diagram of an exemplary operational environment in which the techniques of the present invention may be employed;

FIG. 5 is a diagram showing sequences of transmitted symbols in which collisions occur between two channels;

FIG. 6 is a diagram showing sequences of symbols in which repetition of symbols is used to provide collision recovery;

FIG. 7 is a diagram showing an alignment between two different time frequency codes, which results in an increased number of collisions;

FIG. 8 is a diagram showing sequences of symbols in which employment of the same time frequency code for two different channels provides for collision free transmission;

FIGS. 9A and 9B provide examples of transmission timing being based on carrier sensing, according to aspects of the present invention;

FIGS. 10 and 11 are flowcharts showing operations of the present invention;

FIG. 12 is a block diagram of an exemplary wireless communications device, according to an embodiment of the present invention; and

FIG. 13 is a diagram of an IEEE 802.15.3 superframe format.

### DETAILED DESCRIPTION OF THE PREFERRED EMBODIMENTS

I. Frequency Hopping

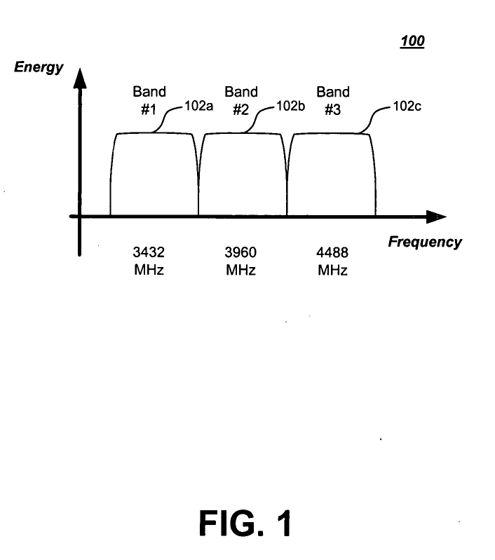

FIG. 1 is a diagram of an available spectrum 100 for a short-range communications system in which the principles of the present invention may be applied, such as an IEEE 802.15.3a network. As shown in FIG. 1, this spectrum includes three frequency bands 102. In particular, spectrum 100 includes a first band 102a centered at 3432 MHz, a second band 102b centered at 3960 MHz, and a third band 102c centered at 4488 MHz.

According to MBO, bands 102 may be used as hopping channels. When used in this manner, each symbol (e.g., each OFDM symbol) is transmitted in one of bands 102 according to a pre-defined code. In IEEE 802.15.3a, such a code is referred to as a time frequency code (TFC). This technique provides for frequency diversity, as well as robustness against multi-path propagation and interference. In addition, this technique allows for multiple-access by utilizing different TFCs for adjacent piconets.

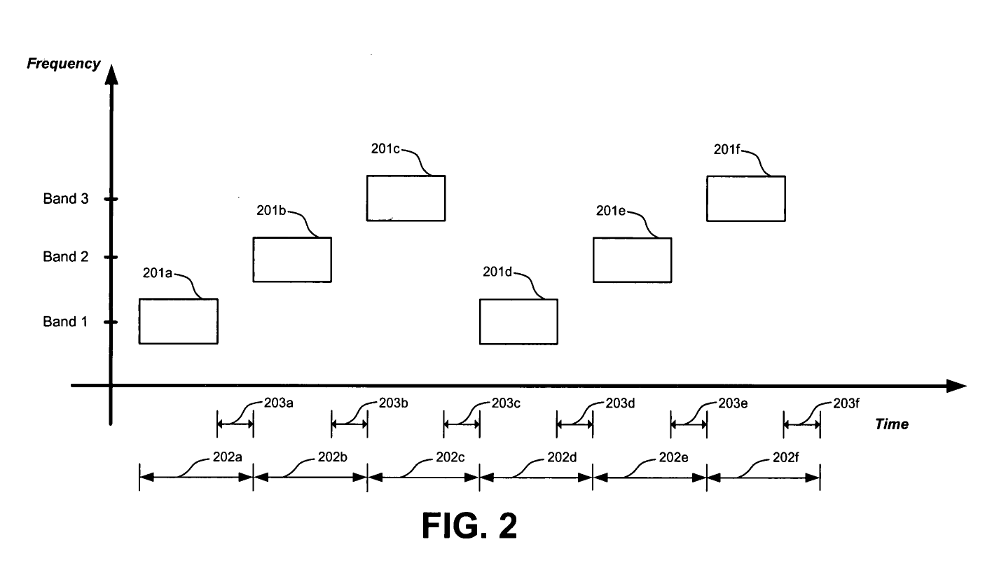

An example of this frequency-hopping technique is shown in FIG. 2. FIG. 2 is a diagram showing signal transmission that employs a particular TFC. In this TFC, symbols are transmitted at frequencies according to a repeating sequence. As shown in FIG. 2, this sequence is first band 102a, followed by second band 102b, followed by third band 102c.

FIG. 2 also shows a sequence of symbols 201, which are transmitted by a wireless communications device. The time intervals between the beginning of consecutively transmitted symbols (such as symbols 201a and 201b) are referred to herein as time slots. Accordingly, FIG. 2 shows time slots 202a-f, which correspond to symbols 201a-f, respectively. Within each time slot 202, a zero padding portion 203 exists between successively transmitted symbols. FIG. 2 shows a zero padding portion 203a between symbols 201a and 201b. During zero padding portions 203, the transmitting wireless communications device refrains from transmitting energy (i.e., signals). Therefore, these portions reduce the likelihood of interference between adjacently transmitted symbols 201.

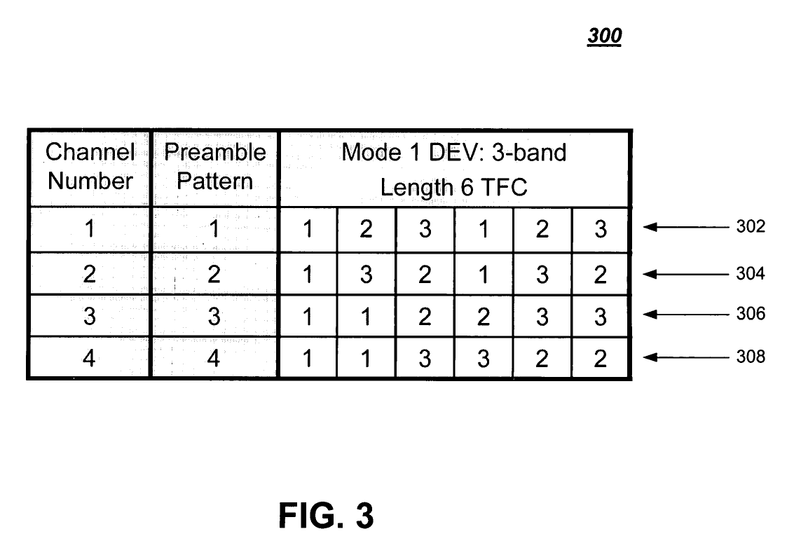

According to the MBO proposal, different TFC codes may be used to support multiple piconets in the same area. Since spectrum 100 provides only three channels, a limited number of different hopping sequences (i.e., TFCS) are available. FIG. 3 is a table showing various TFC codes used for the spectrum of FIG. 1. In this table, “1” refers to band 102a, “2” refers to band 102b, and “3” refers to band 102c. In FIG. 3, a TFC 302 employs the band sequence 1, 2, 3, 1, 2, 3, while a TFC 304 employs the band sequence 1, 3, 2, 1, 3, 2.

II. Operational Environment

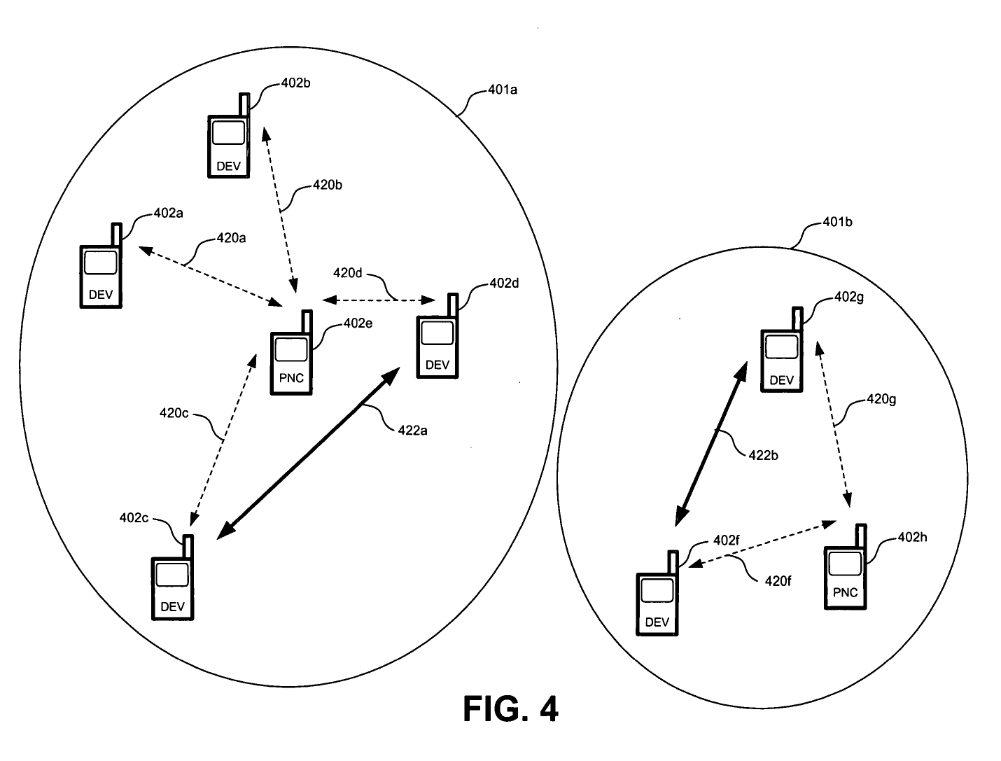

FIG. 4 is a diagram of an exemplary operational environment in which the techniques of the present invention may be employed. This environment includes multiple piconets 401, each having a plurality of devices 402. For instance, FIG. 4 shows a piconet 401a, which includes a piconet coordinator (PNC) 402e, and member devices (DEVs) 402a-d. FIG. 4 also shows a piconet 401b, which includes a PNC 402h, as well as DEVs 402f and 402g.

In piconet 401a, each of devices 402a-d communicate with PNC 402e across a corresponding link 420. For example, DEV 402a communicates with PNC 402e across a link 420a. In addition, DEVs 420a-d may communicate with each other directly. For instance, FIG. 4 shows DEVs 402c and 402d communicating via a direct link 422a.

In piconet 401b, each of DEVs 402f and 402g may communicate with PNC 402h across a corresponding link 420. For instance, DEV 402f communicates with PNC 402h across a link 420f, while DEV 402g communicates with PNC 402h across a link 420g. Member devices in piconet 401b may also communicate with each other directly. For example, FIG. 4 shows DEVs 402f and 402g communicating across a link 422b.

Each of links 422 and 420 may employ various frequency hopping patterns (i.e., TFCs). These patterns may include, for example, one or more TFCs. In embodiments of the present invention, each piconet 401 employs a particular frequency hopping pattern. These patterns may either be the same or different.

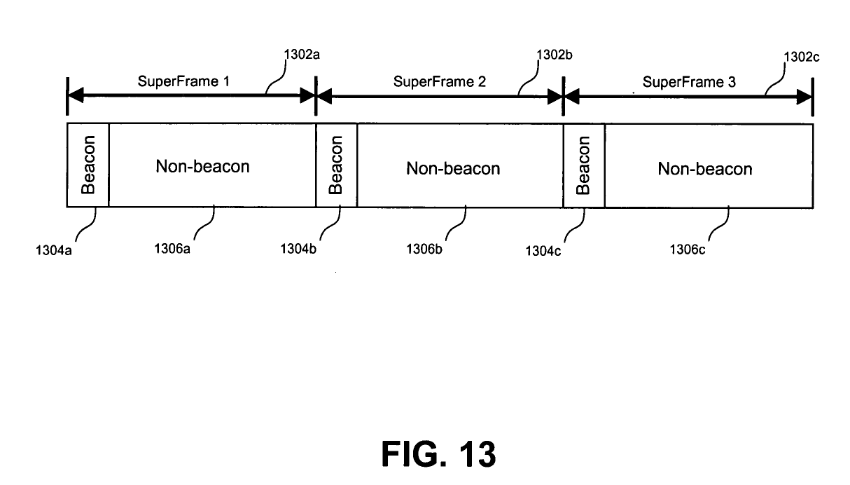

Transmissions of piconets 401a and 401b are each based on a repeating pattern called a superframe. Accordingly, FIG. 13 is a diagram showing an IEEE 802.15.3 superframe format. In particular, FIG. 13 shows a frame format having superframes 1302a, 1302b, and 1302c. As shown in FIG. 13, superframe 1302b immediately follows superframe 1302a, and superframe 1302c immediately follows superframe 1302b.

Each superframe 1302 includes a beacon portion 1304 and a non-beacon portion 1306. Beacon portions 1304 convey transmissions from a PNC (such as PNC 402e) and are used to set timing allocations and to communicate management information for the piconet. For example, beacon portions 1304 may convey transmissions that direct devices in piconet 401a (e.g., DEVs 402a-d) to employ certain frequency hopping patterns, such as specific TFCs. Moreover, beacon portions 1304 may be used to transmit requests for identity of other piconets within communications range. According to the present invention, such requests may also ask for information regarding the frequency hopping patterns employed by the other piconets. Such request are called scans.

Non-beacon portions 1306 are used for devices to communicate data according to, for example, the frequency hopping techniques described herein. For instance, non-beacon portions 1306 may support data communications across links 420 and 422. In addition, devices (e.g., DEVs 402a-d) may use non-beacon portions 606 to transmit control information, such as request messages to other devices (e.g., PNC 402e).

III. Channel Collisions

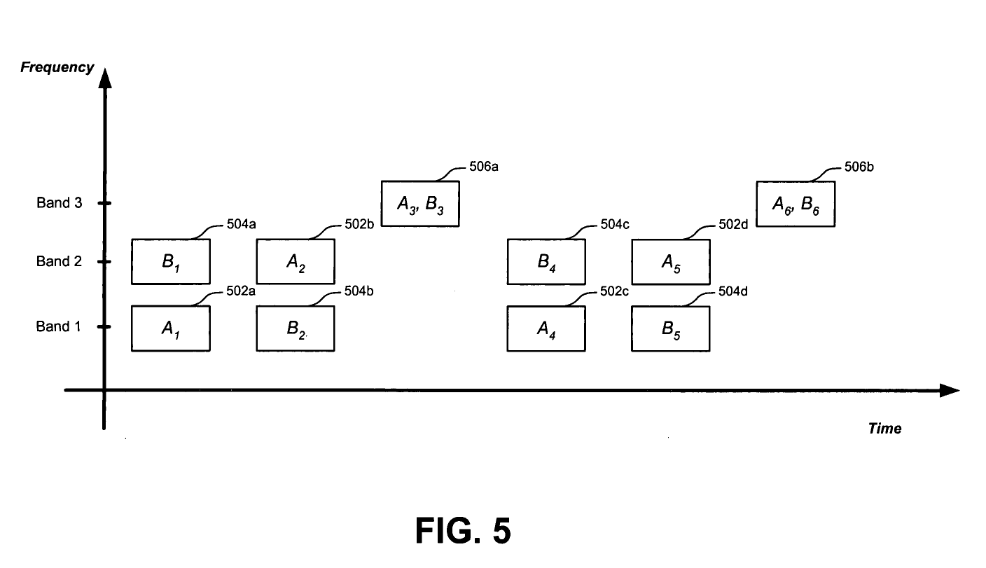

FIG. 5 is a diagram showing sequences of transmitted symbols in which collisions occur between two channels, referred to herein as channels A and B. These channels employ frequency hopping patterns, and may be associated with different wireless networks, such as piconets 401a and 401b. As shown in FIG. 5, the sequence corresponding to channel A includes symbols A₁, A₂, A₃, A₄, A₅, and A₆, while the sequence corresponding to channel B includes symbols B₁, B₂, B₃, B₄, B₅, and B₆.

FIG. 5 shows that the sequence corresponding to channel A is transmitted according to TFC 302. As described above, TFC 302 employs the band sequence 1, 2, 3, 1, 2, 3. In contrast, the sequence corresponding to channel B is transmitted according to TFC 304. As described above, TFC 304 employs the band sequence 1, 3, 2, 1, 3, 2. However, FIG. 5 shows this TFC being time shifted as the band sequence 2, 1, 3, 2, 1, 3.

As shown in FIG. 5, two thirds of the symbols associated with channels A and B (indicated by reference numbers 502 and 504) do not interfere or collide with each other. However, the remaining third of these symbols collide. These collisions are indicated in FIG. 5 by reference number 506

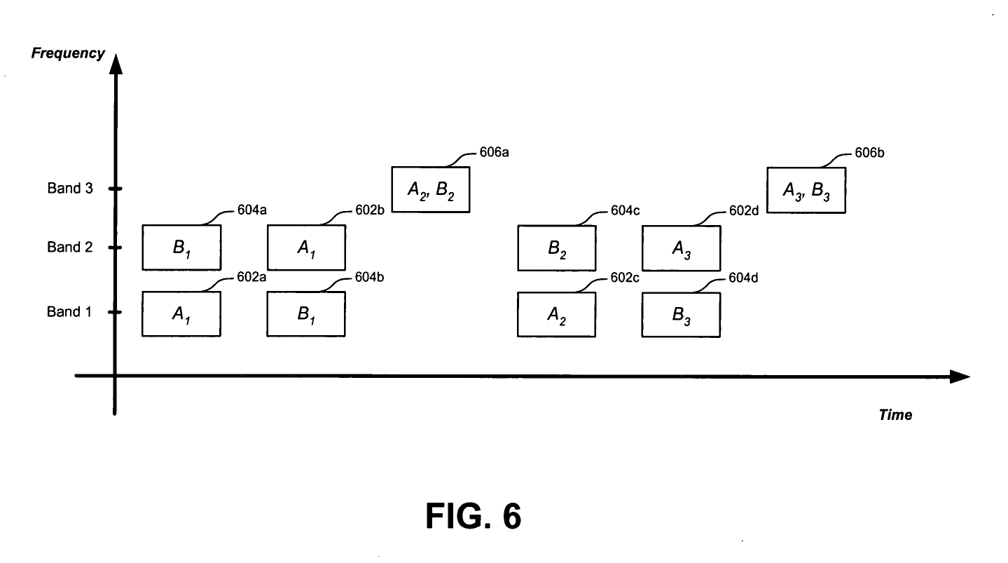

One approach to overcoming such collisions is to employ symbol repetition techniques. An example of such a technique is shown in FIG. 6. FIG. 6 is a diagram showing sequences of transmitted symbols associated with channels A and B. As in FIG. 5, channel A employs TFC 302, while channel B employs TFC 304.

However, in FIG. 6, each symbol of channels A and B are repeated. More particularly, FIG. 6 shows the sequence for channel A as symbols A₁, A₁, A₂, A₂, A₃, and A₃. Similarly, FIG. 6 shows the sequence for channel B as symbols B₁, B₁, B₂, B₂, B₃, and B₃. Therefore, such repetition techniques can significantly reduce data rates, as well as network capacity.

However, such techniques provide for collision recovery. For instance, FIG. 6 shows that two thirds of the symbols associated with channels A and B (indicated by reference numbers 602 and 604) do not interfere or collide with each other. However, the remaining third of these symbols collide. These collisions are indicated in FIG. 6 by reference number 606. To provide for collision recovery, the symbols associated with each collision 606 are repeated in the next time slot. For example, FIG. 6 shows that collision 606a occurs between symbols A₂ and B₂. However, 602c and 604c are repetitions of these symbols that do not collide.

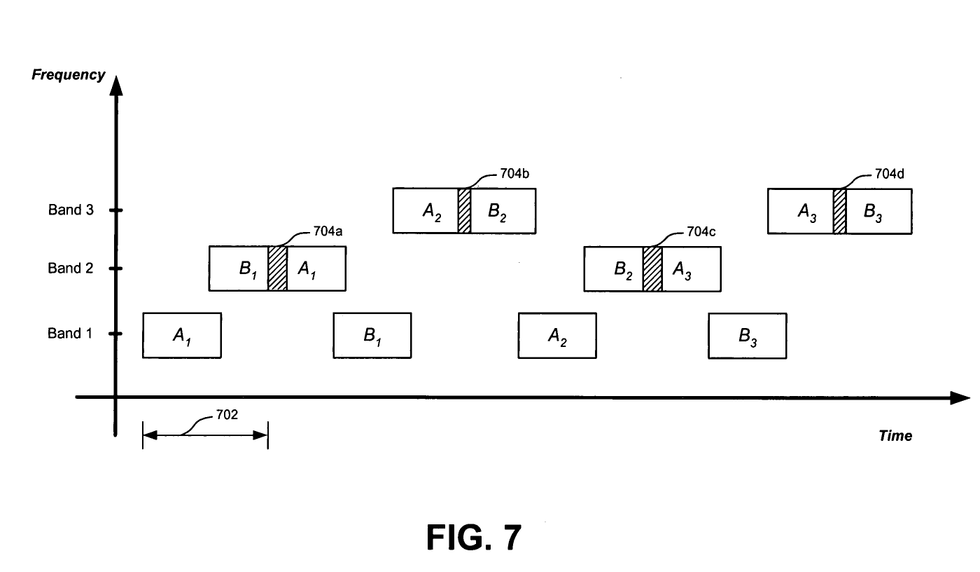

FIGS. 5 and 6 show that appropriate synchronization between different frequency hopping patterns (e.g., TFCs), can provide for the minimization of collisions. However, failure to provide appropriate synchronization may increase the occurrence of collisions. An example of such an increase is shown in FIG. 7.

FIG. 7 shows an alignment between TFCs 302 and 304 that results in a greater number of collisions. As in FIGS. 5 and 6, FIG. 7 shows TFC 302 being associated with channel A and TFC 304 being associated with channel B. However, the timing of these TFCs is such that TFC 302 is too early and/or TFC 304 is too late (with respect to each other) for avoiding interference. The relative timing between these TFCs is indicated by a timing offset 702. By employing timing offset 702, collisions 704 occur in bands 2 and 3. Thus, two thirds of the symbols transmitted in FIG. 7 are corrupted or lost due to collisions.

IV. Collision Free Transmission

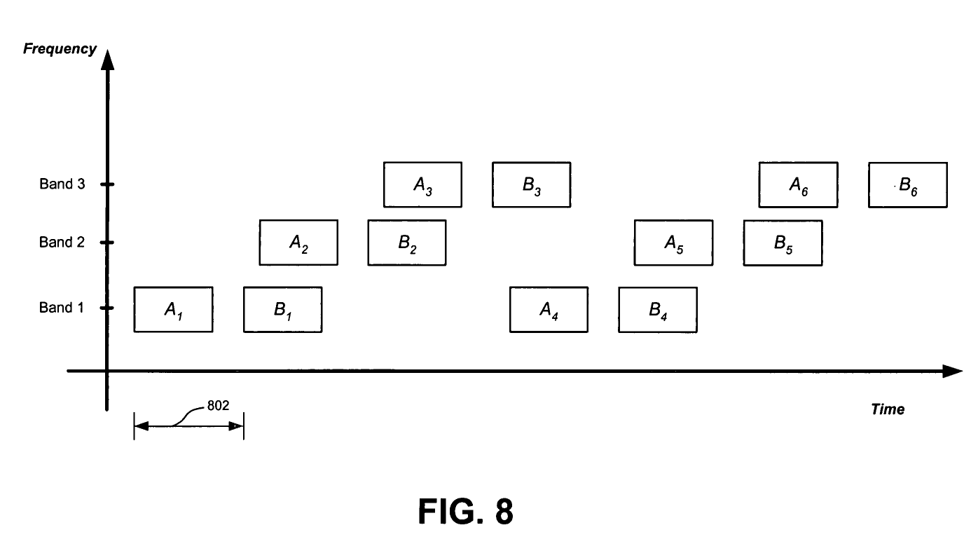

When two channels employ the same TFC, collision-free transmission may occur when an appropriate synchronization between the channels is employed. An example of such synchronization is shown in FIG. 8. In this example, channels A and B both employ TFC 302. The relative timing between these TFCs is indicated by a time offset 802. By employing time offset 802, the symbols of channel A (i.e., symbols A₁, A₂, A₃, A₄, A₅, and A₆) do not collide with the symbols of channel B (i.e., symbols B₁, B₂, B₃, B₄, B₅, and B₆).

V. Synchronization Techniques

According to the present invention, some or all devices in a wireless network, such as a piconet, use carrier sensing before transmitting according to a selected frequency hopping pattern (e.g., a TFC). This advantageously provides synchronization with data traffic from other sources, such as nearby piconets. By employing carrier sensing, a device is able to time its transmissions (i.e., the timing of its selected frequency hopping pattern) in such a way that collisions between its transmissions and other existing transmissions are either minimized or eliminated.

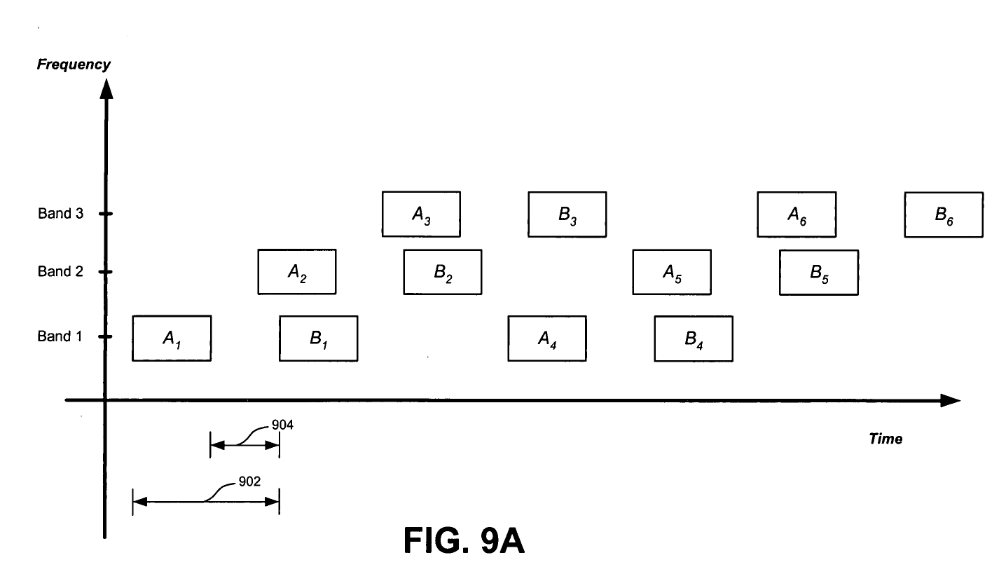

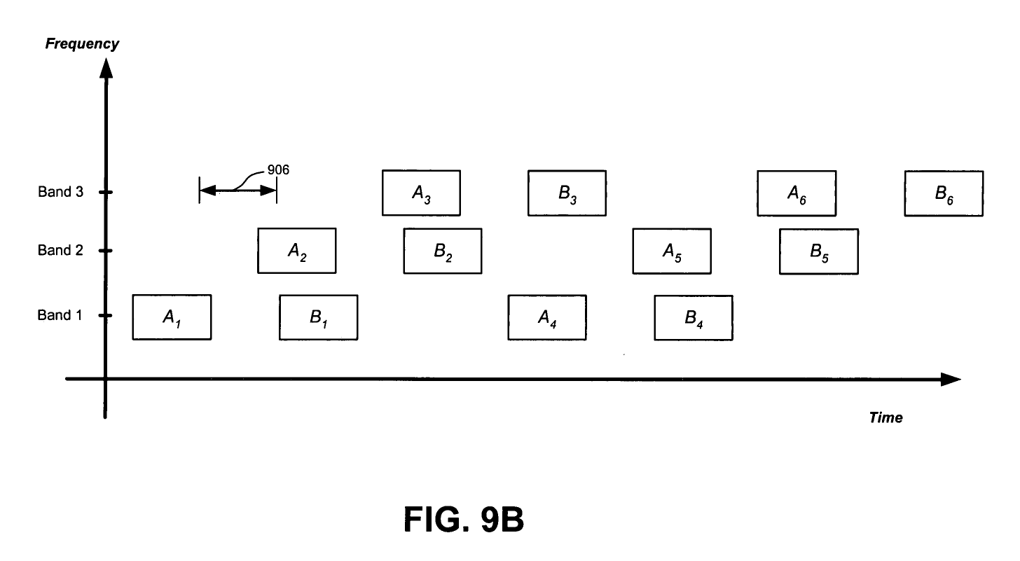

When other piconets do not exist within a predetermined range of a device's piconet, the carrier sensing techniques of the present invention may be optionally performed, because delays associated with carrier sensing may decrease a device's gross data rate. Thus, the performance of such techniques may be limited to situations where the potential for interference exists. In embodiments of the present invention, carrier sensing is performed before the transmission of every packet. However, in further embodiments, carrier sensing is not performed before every packet transmission. Rather, carrier sensing timing may be selected according to various techniques, depending on for example delay 904, as described below with reference to FIG. 9A, and clock drifts.

As described above, two networks or devices may employ the same or different TFCs. When the same TFC is used, the techniques of the present invention provide for the elimination of collisions between the two piconets or devices. When different TFCs are used, the techniques of the present invention minimize the number of collisions. Examples of the elimination and minimization of collisions are described above with reference to FIGS. 5, 6, and 8.

FIGS. 9A and 9B provide examples of transmission timing being based on carrier sensing, according to aspects of the present invention. In these examples, a device associated with channel B employs carrier sensing while in the transmission mode. This carrier sensing, as well as a knowledge of channel A's TFC, enables the device to obtain proper synchronization with a device or network utilizing channel A. In these examples, channels A and B both employ the same TFCs (i.e., TFC 302). However, these techniques may be employed where channels A and B employ different TFCs.

FIG. 9A shows a carrier sensing period 902 during which the device associated with channel B performs carrier sensing to monitor (or “listen to”) to band 1. During period 902, the device detects energy in band 1 associated with the symbol A₁. Also during this period, the device detects that the energy in band 1 vanishes upon the completion of symbol A₁. As shown in FIG. 9A, period 902 includes a predetermined delay 904 that begins when this energy vanishes. Upon completion of this delay, the device begins transmitting according to its selected TFC. This results in no collisions occurring between channels A and B.

In the example of FIG. 9B, the device associated with channel B monitors a different band than the band in which it will begin transmitting. In particular, this device monitors band 3, but will commence its transmissions in band 1. For instance, the device associated with channel B listens to band 3 during a carrier sensing period 906. By determining that there is no symbol energy during period 906, the device associated with channel B knows that the device associated with channel A cannot overlap with band 1 because according to TFC 302, this device will transmit in band 3 before band 1. Thus, the device associated with channel B determines that it can start transmitting in Band 1 according to TFC 302 without causing collisions.

Accordingly, in FIGS. 9A and 9B, synchronization is achieved such that the transmissions in channels A and B do not collide because their symbols are not transmitted in the same band at the same time. As described above, channels A and B may be associated with different piconets, such as piconets 401a and 401b.

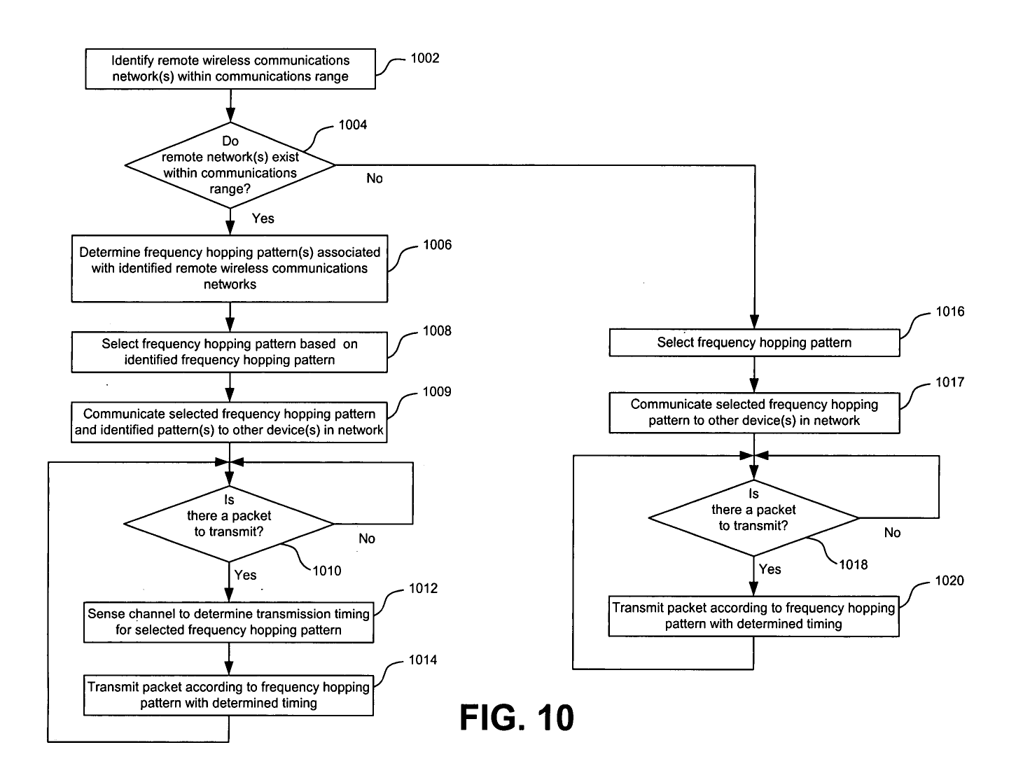

FIG. 10 is a flowchart showing an operation of a wireless communications device, according to embodiments of the present invention. This operation may be performed by a device that coordinates communications in a wireless network, such as a PNC. Alternatively, the operation may be performed by another device in response to a designation from a PNC.

As shown in FIG. 10, this operation includes a step 1002, in which the device identifies one or more remote wireless communications networks, such as piconets, that are within communications range of the device. As indicated by a step 1004, operation proceeds to a step 1006 if any remote networks (and associated frequency hopping patterns): were identified in step 1002. Otherwise, operation proceeds to a step 1016.

In step 1006, the device determines frequency hopping pattern(s) associated with any remote networks identified in step 1002. The identification of remote networks and their frequency hopping patterns may be performed according to various techniques. For example, a device may measure energy (e.g., perform carrier sensing) in one or more frequency bands. Also, a device may listen for beacons of other piconets to ascertain their frequency hopping patterns. Further, a device may exchange data with existing networks. Such exchanges may include the transmission of requests regarding frequency hopping information and the reception of responses to these request from devices in remote networks.

In a step 1008, the device selects a frequency hopping pattern for its network. This selection is based on the frequency hopping pattern(s) determined in step 1006. In embodiments of the present invention, this step may include selecting the same pattern (e.g., the same TFC) that is used by a neighboring network. As described above, this can advantageously eliminate the occurrence of collisions. However, in further embodiments, this step may include selecting a pattern that is different from the pattern(s) determined in step 1006.

A step 1009 follows step 1008. In this step, the device communicates (i.e., distributes) information conveying the selected frequency hopping pattern, as well as the frequency hopping pattern(s) identified in step 1006 to the other devices in the device's network. In piconet implementations, this step may comprise transmitting one or more messages during the beacon portion of one or more frames.

In step 1010, the device determines whether it has a packet to transmit. A packet may include one or more symbols (e.g., OFDM symbols). Accordingly, transmission of a packet may involve transmitting at various frequencies according to the selected frequency hopping pattern. If the device has a packet to transmit, a step 1012 is performed.

In step 1012, the device performs carrier sensing on a band to determine when to transmit the packet according to the frequency hopping pattern selected in step 1008. This is performed to avoid collisions with other transmissions. In embodiments, this step may include monitoring transmissions in a frequency band, identifying a low energy condition in the frequency band, and designating a starting time for the selected frequency hopping pattern during the low energy condition. Examples of this technique are described above with reference to FIGS. 9A and 9B.

Next, in a step 1014, the device transmits the packet according to the selected frequency hopping pattern at the timing determined in step 1012. After step 1014, operation returns to step 1010, where the device determines whether there is another packet to transmit.

As described above, a step 1016 is performed if no remote networks exist within communications range of the device. In step 1016, the device selects a frequency hopping pattern for its network. Next, in a step 1017, the device communicates the selected frequency hopping pattern to the other device(s) in its network. In piconet implementations, this step may comprise transmitting one or more messages during the beacon portion of one or more frames.

Next, the device determines in step 1018 whether it has a packet to transmit. If so, then a step 1020 is performed. In this step, the device transmits the packet according to the frequency hopping pattern (e.g., TFC) selected in step 1020. After step 1020, operation returns to step 1018, where the device determines whether there is another packet to transmit.

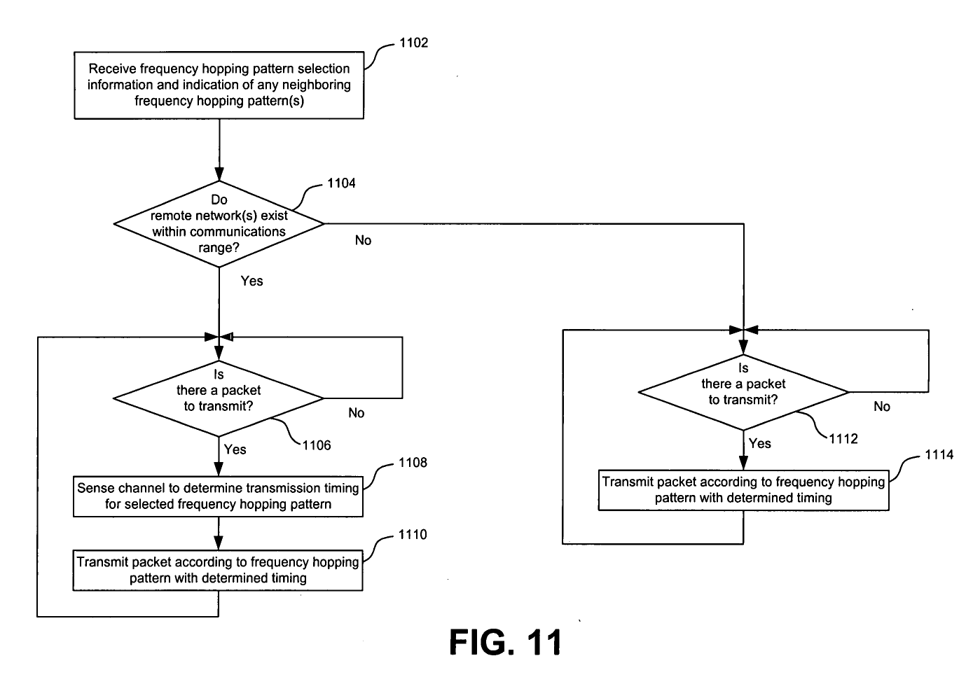

FIG. 11 is a flowchart showing an operation of a device that receives information regarding its frequency hopping pattern, as well as information regarding frequency hopping patterns of neighboring networks, from a remote device such as a PNC. As shown in FIG. 11, this operation includes a step 1102. In this step, the device receives information regarding the selected frequency hopping pattern, as well as information regarding the existence of any neighboring networks and their frequency hopping pattern(s). Such neighboring networks may be detectable by the device. However, some of these neighboring networks may not currently be within range to be detectable.

As indicated by a step 1104, operation proceeds to a step 1106 if any remote networks (and associated frequency hopping patterns) were identified in step 1102. Otherwise, operation proceeds to a step 1106. In step 1106, the device determines whether it has a packet to transmit. A packet may include one or more symbols (e.g., OFDM symbols). Accordingly, transmission of a packet may involve transmitting at various frequencies according to the selected frequency hopping pattern.

If the device has a packet to transmit, a step 1108 is performed. In this step, the device performs carrier sensing on a band to determine when to transmit the packet according to the selected frequency hopping pattern (e.g., TFC), which was received in step 1102. Next, in a step 1110, the device transmits the packet according to the selected frequency hopping pattern at the timing determined in step 1108. After step 1110, operation returns to step 1106, where the device determines whether there is another packet to transmit.

As described above, a step 1112 is performed if no remote networks (and associated frequency hopping patterns) were identified in step 1102. In this step, the device determines whether it has a packet to transmit. If so, then a step 1114 is performed. In step 1114, the device transmits the packet according to the selected frequency hopping pattern (e.g., TFC), which was received in step 1102. After step 1114, operation returns to step 1112, where the device determines whether there is another packet to transmit.

VI. Device Implementation

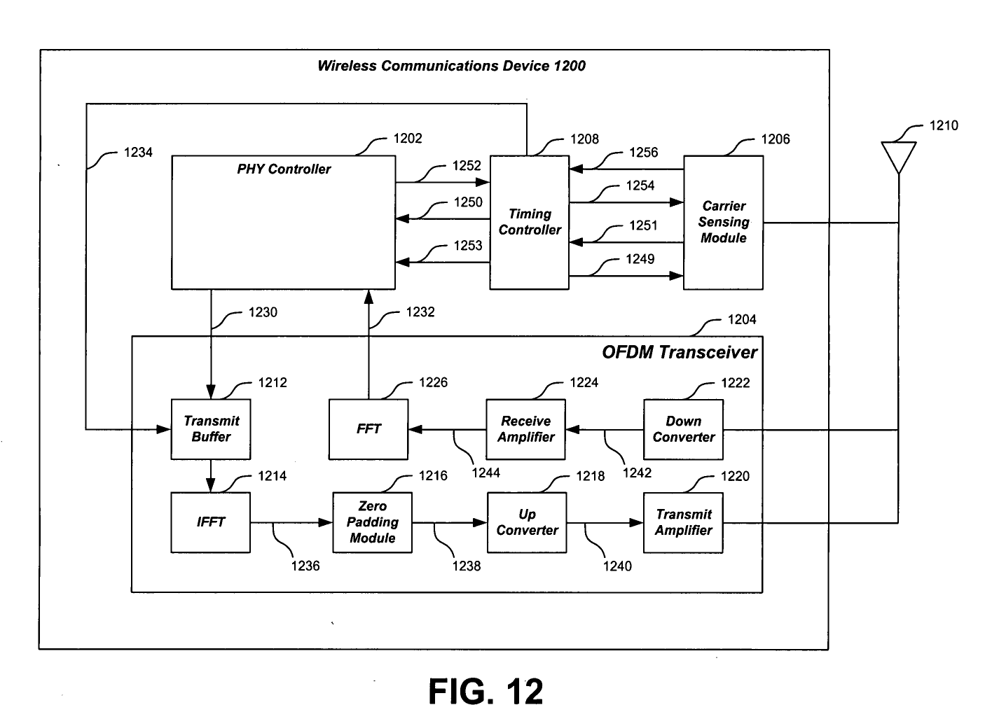

FIG. 12 is a diagram of a wireless communications device 1200, which may operate according to the techniques of the present invention. This device may be used in various communications environments, such as the environment of FIG. 4. Accordingly, device 1200 may engage in communications across wireless links, such as links 422 and 420. As shown in FIG. 12, device 1200 includes a physical layer (PHY) controller 1202, an OFDM transceiver 1204, a carrier sensing module 1206, a timing controller 1208, and an antenna 1210.

PHY controller 1202 generates packets 1230, which are sent to OFDM transceiver 1204 for wireless transmission via antenna 1210. These packets may convey information, such as payload data associated with applications, as well as header information. Such header information may be associated with the physical layer, as well as other protocol layers such as the media access control (MAC) layer. In addition, PHY controller 1202 receives packets 1232 from OFDM transceiver 1204 that are originated from remote wireless communications devices. These packets may convey information, such as payload data associated with applications, as well as header information.

FIG. 12 shows that OFDM transceiver 1204 includes a transmit buffer 1212, an inverse fast fourier transform (IFFT) module 1214, a zero padding module 1216, an upconverter 1218, and a transmit amplifier 1220. Transmit buffer 1212 stores packets 1230, which are received from PHY controller 1202. One or more of these packets are sent to IFFT module 1214 in response to a transmit signal 1234 that is generated by timing controller 1208.

IFFT module 1214 generates an OFDM modulated signal 1236 from each packet 1230 that is received from transmit buffer 1212. This generation involves performing one or more inverse fast fourier transform operations. As a result, signal 1236 includes one or more OFDM symbols. FIG. 12 shows that signal 1236 is sent to zero padding module 1216, which appends one or more “zero samples” to the beginning of each OFDM symbol in signal 1236. This produces a padded modulated signal 1238.

Upconverter 1218 receives padded signal 1238 and employs carrier-based techniques to place padded signal 1238 into one or more frequency bands. These one or more frequency bands are determined according to a frequency hopping pattern, such as one or more of the TFCs described above. As a result, upconverter 1218 produces a frequency hopping signal 1240, which is amplified by transmit amplifier 1220 and transmitted through antenna 1210.

FIG. 12 shows that OFDM transceiver 1204 further includes a downconverter 1222, a receive amplifier 1224, and a fast fourier transform (FFT) module 1226. These components are employed in the reception of wireless signals from remote devices. In particular, antenna 1210 receives wireless signals from remote devices and sends them to downconverter 1222. These wireless signals employ frequency hopping patterns, such as one or more of the TFCs described above.

Upon receipt, downconverter 1222 employs carrier-based techniques to convert these signals from its one or more frequency hopping bands (e.g., TFC bands) into a predetermined lower frequency range. This results in a modulated signal 1242, which is sent to receive amplifier 1224. Amplifier 1224 generates an amplified signal 1244 from signal 1242 and passes it to FFT module 1226 for OFDM demodulation. This demodulation involves performing a fast fourier transform for each symbol that is conveyed in signal 1244.

As a result of this demodulation, FFT module 1226 produces one or more packets 1232. As described above, packets 1232 are sent to PHY controller 1202. These packets may convey various information, such as payload data and protocol header(s). Upon receipt, PHY controller 1202 processes packets 1232. This may involve sending portions of these packets (e.g., payload data) to higher level processes, such as one or more applications (not shown).

Timing controller 1208 controls the timing of transmissions for device 1200. In an embodiment of the present invention, timing controller 1208 initiates a scan message 1250 that inquires about neighboring networks and the frequency hopping patterns they employ. As shown in FIG. 12, scan message 1250 is sent to PHY controller 1202, which places this message into one or more packets 1230. These packets are then processed and transmitted via antenna 1210.

If any remote networks exist within communications range, device 1200 receives one or more responses originated by these remote network(s). Each of these responses includes information regarding the frequency hopping pattern employed by the corresponding remote network. OFDM transceiver 1204 receives each of these responses through antenna 1210 and produces one or more packets 1232, which convey a scan response message 1252. PHY controller 1202 processes these packets and sends scan response message 1252 to timing controller 1208.

In further embodiments, device 1200 identifies other networks and their frequency hopping patterns by monitoring (e.g., carrier sensing) one or frequency bands. Accordingly, timing controller may alternatively generate an initiate scan instruction 1249, which is sent to carrier sensing module 1206. Upon receipt of this instruction, module 1206 performs carrier sensing on one or more frequency bands. For example, module 1206 may perform carrier sensing of a particular frequency band. When module 1206 detects an energy level in this band, it performs carrier sensing on one or more other bands to identify a remote network's frequency hopping pattern (e.g., TFC).

Upon recognition of one or more frequency hopping patterns, carrier sensing module 1206 sends a scan response message 1251 to timing controller. This message indicates any frequency hopping patterns identified by the aforementioned carrier sensing based scanning.

Based on any received scan response messages 1251 or 1252, timing controller 1208 selects a frequency hopping pattern for use by device 1200 and any other devices in its network. Timing controller 1208 may then generate a frequency hopping message 1253, which includes the selected frequency hopping pattern. In addition, message 1253 may include the frequency hopping pattern(s) of any remote networks. As shown in FIG. 12, message 1253 is sent to PHY controller, which places this message into one or more packets 1230. These packets are then processed and transmitted via antenna 1210 to the other devices.

Once the scan response messages (if any) are received and a frequency hopping pattern is selected, timing controller 1208 sends a command 1254 to carrier sensing module 1206. This command designates a frequency band for carrier sensing module. 1206 to monitor. As shown in FIG. 12, carrier sensing module 1206 is coupled to antenna 1210. Accordingly, carrier sensing module 1206 monitors energy received by antenna 1210 in the frequency band specified by command 1254. Carrier sensing module 1206 generates detection signals 1256, which indicate transitions between the presence and absence of energy in the monitored frequency band.

Based on signals 1256, timing controller 1208 determines when transmissions may commence for device 1200. At the occurrence of such a determined time, timing controller 1208 generates transmit signal 1234. As described above, this signal instructs transmit buffer 1212 to send one or more stored packets to IFFT module 1214 so that transmissions may commence according to the selected frequency hopping pattern.

As described above with reference to FIG. 11, in embodiments of the present invention, devices do not initiate an inquiry or scan regarding neighboring devices or networks. Rather, these devices may receive information regarding selected frequency hopping patterns, and the frequency hopping patterns of any neighboring networks from another device within the same network. Accordingly, in such embodiments, device 1200 does not originate scan messages 1249 or 1250, or frequency hopping message 1253. Also, in such embodiments, scan response message 1252 is not a scan response. Rather, message 1252 may be a message from another device within the same network (such as a PNC), which conveys the selected frequency hopping pattern and the frequency hopping pattern(s) of any remote networks.

Carrier sensing module 1206 may perform monitoring and scanning, as described herein, according to various techniques. Examples of such techniques include energy detection and correlation-based approaches.

The devices of FIG. 12 may be implemented in hardware, software, firmware, or any combination thereof. For instance, carrier sensing module 1206, upconverter 1218, transmit amplifier 1220, receive amplifier 1224, and downconverter 1222 may include electronics, such as amplifiers, mixers, and filters. Moreover, implementations of device 1200 may include digital signal processor(s) (DSPs) to implement various modules, such as carrier sensing module 1206, transmit buffer 1212, IFFT module 1214, zero padding module 1216, and FFT module 1226. Moreover, in embodiments of the present invention, processor(s), such as microprocessors, executing instructions (i.e., software) that are stored in memory (not shown) may be used to control the operation of various components in device 1200. For instance, components, such as PHY controller 1202, timing controller 1208, and transmit buffer 1212, may be primarily implemented through software operating on one or more processors.

VII. Conclusion

While various embodiments of the present invention have been described above, it should be understood that they have been presented by way of example only, and not in limitation. For instance, although examples have been described involving IEEE 802.15.3 and/or IEEE 802.15.3a communications, other short-range and longer-range communications technologies are within the scope of the present invention. Also, the present invention is not limited to implementations involving only three frequency channels. Moreover, the techniques of the present invention may be used with signal transmission techniques other than OFDM and TFCs.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method in a wireless communications device, comprising:
(a) identifying a frequency hopping pattern associated with a remote short-range wireless communications network;
(b) based on the identified frequency hopping pattern, selecting a frequency hopping pattern for communications in a local short-range wireless communications network; and
(c) based on the identified frequency hopping pattern, selecting a timing for the selected frequency hopping pattern.

2. The method of claim 1, further comprising:
transmitting one or more symbols according to the selected frequency hopping pattern and the selected timing.

3. The method of claim 2, wherein the one or more symbols are OFDM symbols.

4. The method of claim 1, wherein step (c) comprises:
identifying a low energy condition in the frequency band; and
designating a starting time for the selected frequency hopping pattern during the low energy condition.

5. The method of claim 1, wherein step (c) comprises:
monitoring transmissions in a frequency band;
identifying a low energy condition in the frequency band; and
designating a starting time for the selected frequency hopping pattern during the low energy condition.

6. The method of claim 1, wherein the identified frequency hopping pattern and the selected frequency hopping pattern are the same.

7. The method of claim 1, wherein the selected timing provides for no collisions between the identified frequency hopping pattern and the selected frequency hopping pattern.

8. The method of claim 1, wherein the identified frequency hopping pattern and the selected frequency hopping pattern are different.

9. The method of claim 8, wherein the selected timing provides for minimal collisions between the identified frequency hopping pattern and the selected frequency hopping pattern.

10. The method of claim 1, further comprising:
directing one or more remote wireless communications devices to employ the selected frequency hopping pattern.

11. A system, comprising:
means for identifying a frequency hopping pattern associated with a remote short-range wireless communications network;
means for selecting a frequency hopping pattern for communications in a local short-range wireless communications network based on the identified frequency hopping pattern; and
means for selecting a timing for the selected frequency hopping pattern based on the identified frequency hopping pattern.

12. The system of claim 11, further comprising:
means for transmitting one or more symbols according to the selected frequency hopping pattern and the selected timing.

13. The system of claim 11, wherein the one or more symbols are OFDM symbols.

14. The system of claim 11, wherein said means for selecting a timing comprises:
means for monitoring transmissions in a frequency band;
means for identifying a low energy condition in the frequency band; and
means for designating a starting time for the selected frequency hopping pattern during the low energy condition.

15. The system of claim 11, wherein the identified frequency hopping pattern and the selected frequency hopping pattern are the same.

16. The system of claim 11, wherein the selected timing provides for no collisions between the identified frequency hopping pattern and the selected frequency hopping pattern.

17. The system of claim 11, wherein the identified frequency hopping pattern and the selected frequency hopping pattern are different.

18. The system of claim 17, wherein the selected timing provides for minimal collisions between the identified frequency hopping pattern and the selected frequency hopping pattern.

19. The system of claim 11, further comprising:
means for directing one or more remote wireless communications devices to employ the selected frequency hopping pattern.

20. A wireless communications device, comprising:
a carrier sensing module configured to monitor transmissions in one or more frequency bands;
a timing controller configured to select a frequency hopping pattern for a local short-range wireless network based on a frequency hopping pattern of a remote short-range wireless communications network detected by the carrier sensing module, and to control one or more transmission times according to the selected frequency hopping pattern based on energy levels detected in a frequency band by the carrier sensing module; and
a transceiver configured to transmit data at the one or more data transmission times according to the selected frequency hopping pattern.

21. The wireless communications device of claim 20, wherein the transceiver is further configured to transmit the selected frequency hopping pattern to one or more devices in the local short-range wireless network.

22. The wireless communications device of claim 21, wherein the transceiver is further configured to transmit the selected frequency hopping pattern to the one or more devices in the local short-range wireless network in a beacon transmission.

23. A wireless communications device, comprising:
a carrier sensing module configured to monitor transmissions in one or more frequency bands;
a timing controller configured to control one or more transmission times according to a frequency hopping pattern based on energy levels detected in a frequency band by the carrier sensing module; and
a transceiver configured to receive the frequency hopping pattern from a device in the local short-range wireless communications network, and to transmit data at the one or more data transmission times according to the frequency hopping pattern.

24. The wireless communications device of claim 23, wherein the transceiver is further configured to receive the frequency hopping pattern in a beacon transmission.

25. A method in a wireless communications device, comprising:
monitoring transmissions in one or more frequency bands of a plurality of channels;
based on the monitored transmissions, determining a time frequency code (TFC) of a remote short-range wireless communications network;
selecting a TFC for use in a local short-range wireless communications network based on the TFC of the remote wireless communications network;
distributing information regarding the selected TFC to one or more remote devices within the local short-range wireless communications network;
determining whether the wireless communications device needs to transmit data within the local short-range wireless communications network; and
monitoring one or more of the frequency bands to designate a transmission timing for the data.
